(19) United States
(12) Patent Application Publication
(10) Pub. No.: US 2026/0146336 A1
(43) Pub. Date: May 28, 2026

(54) METHOD FOR THE ANTI-CORROSION TREATMENT OF A MAGNESIUM ALLOY PART, CORRESPONDING ANTI-CORROSION SUBSTANCE AND TREATED PART

(71) Applicant: AIRBUS HELICOPTERS, Marignane Cedex (FR)

(72) Inventors: Séverine HEYRAUD, Salon-De-Provence (FR); Sylvain BIANCO, Tapfheim (FR)

(73) Assignee: AIRBUS HELICOPTERS, Marignane Cedex (FR)

(21) Appl. No.: 19/188,514

(22) Filed: Apr. 24, 2025

(30) Foreign Application Priority Data
Apr. 24, 2024 (FR) FR2404217

(51) Int. Cl. C23F 11/173; C08K 3/22; C08K 3/32; C09D 5/08; C09D 7/61; C09D 163/00

(52) U.S. Cl. CPC C23F 11/173; C09D 5/084; C09D 7/61; C09D 163/00; C08K 2003/2262; C08K 2003/324

(57) ABSTRACT

A method for anti-corrosion treatment of a magnesium alloy part, the method comprising bringing a portion of the part, at least locally, into contact with an anti-corrosion substance for a predetermined period, using an applicator member. An anti-corrosion substance contains permanganate MnO₄⁻ ions, dihydrogen phosphate ions H₂PO₄⁻ and an epoxy gel. After the predetermined period, the method comprises rinsing the portion of the part with water.

### CROSS REFERENCE TO RELATED APPLICATION

This application claims priority to French Patent Application No. FR 24 04217 filed on Apr. 24, 2024, the disclosure of which is incorporated in its entirety by reference herein.

### TECHNICAL FIELD

The present disclosure relates to a method for anti-corrosion treatment of a magnesium alloy part, to an anti-corrosion substance for implementing the method, and to a part obtained after treatment according to the method of the disclosure.

### BACKGROUND

Magnesium alloys are mixtures of magnesium and other alloy metals, generally at least one metal selected from aluminum, zinc, silicon, manganese, copper, zirconium, neodymium and gadolinium. Some alloys may also include rare earths.

In addition, one of the remarkable characteristics of magnesium is its density, 1.7 g/cm3 (grams per cubic centimeter); magnesium-based alloys are therefore used when weight gain is an important consideration, for example in aircraft or rotorcraft components and equipment. Magnesium alloys have a hexagonal crystal lattice structure, that is more rigid than a cubic structure. Furthermore, magnesium alloys are generally used as cast alloys.

However, these magnesium alloys can oxidize in the presence of water or water vapor, that can alter their mechanical characteristics and degrade the static or fatigue strength of the parts thus formed.

Document EP1277853 A1 discloses a method for anti-corrosion treatment of a cast plate of a magnesium alloy AZ91D (containing 90% magnesium, 9% aluminum and 1% zinc). The plate is immersed in degreasing agent solution at 40° C. (degrees Celsius) for 10 minutes (10 min), then washed with deionized water for one minute. The plate is then immersed in a potassium hydroxide pickling solution for 15 minutes at 60° C., then washed with deionized water. Finally, it is immersed in one liter (1 L) of an anti-corrosion bath, consisting of an aqueous solution of manganese phosphate containing 100 grams (100 g) of ammonium dihydrogen phosphate and 20 g of potassium permanganate, the pH of which is adjusted to 3.5 with orthophosphoric acid. The bath is performed at 40° C. for 15 minutes. The plate is then rinsed with deionized water and dried.

The process described in the aforementioned document is certainly compliant with certain regulations, such as the REACH regulations, aimed at improving the protection of human health and the environment against the risks related to chemical substances, because the solutions used do not contain hexavalent chromium. This method is suitable for the treatment of parts in a bath. However, when treatments carried out locally on painted parts or parts with equipment are required, the immersion of the parts or the use of a liquid solution risks causing deterioration of these paints or equipment. For these cases, there is therefore a need for a suitable local retouching and repair process without any risk of leakage or infiltration on the parts that may or may not have been previously treated.

Moreover, the aforementioned document does not give information on the thickness of the anti-corrosion layer formed. The thickness of the layer formed is of great importance when it comes to treating parts having precise dimensions that must be respected in order for the part to be able to be used in a mechanism, for example in an engine. The properties of this layer are also of great importance when it concerns a part subjected to variable forces. The influence of the treatment layer on the fatigue strength of the treated alloy is then also important.

Document JP 2003 277944 A discloses an anti-corrosion chemical conversion composition comprising a solution of potassium permanganate (30 g/L or 0.19 mol/L) and sodium dihydrogen phosphate (100 g/L or 0.83 mol/L). The phosphate concentration is preferably between 50,000 ppm (50 g/L) and 100,000 (100 g/L).

Document EP 0 952 193 B1 discloses a method for treating a metal surface, such as a magnesium alloy. The method includes applying an anti-corrosion composition comprising calcium dihydrogen phosphate, manganese phosphate, and an acrylic epoxy resin.

### SUMMARY

An aim of the present disclosure is therefore to provide an anti-corrosion treatment method that can be easily industrialized, that can be applied locally to a portion of the part, and that can ensure the fatigue strength, anti-corrosion performance and compatibility with painting systems of the parts thus treated.

Another aim of the present disclosure is to provide a method that makes it possible to obtain a coating capable of providing anti-corrosion protection of less than 5 micrometers (5 μm) in thickness, the dimensions of which must be respected so that the part can perform its function in a mechanism, or forms a casing capable of housing and guiding a mechanism, for example in rotation or translation.

Another aim of the disclosure is to provide an anti-corrosion substance that does not contain chromium.

Another aim of the present disclosure is to provide an anti-corrosion-treated magnesium alloy part that has an anti-corrosion treatment layer with a thickness of less than 5 μm.

Another aim of the present disclosure is to provide an anti-corrosion-treated magnesium alloy part, for which the anti-corrosion treatment layer has optimum adhesion with regard to paints, in particular according to standard ISO 2409.

The disclosure thus relates to a method for anti-corrosion treatment of a magnesium alloy part, the method comprising bringing a portion of the part, at least locally, into contact with an anti-corrosion substance for a predetermined period, using an applicator member.

According to the disclosure, the method comprises the anti-corrosion substance that contains:
permanganate ions MnO₄⁻;
dihydrogen phosphate ions H₂PO₄⁻; and
an epoxy gel, the pH of which is between 6 and 8,
after mixing, said anti-corrosion substance comprising a molar concentration of permanganate ions greater than or equal to 0.06 mol/L (moles per liter) and less than or equal to 0.31 mol/L, and a molar concentration of dihydrogen phosphate ions greater than or equal to 0.47 mol/L (moles per liter) and less than or equal to 0.63 mol/L, and preferably between 0.51 mol/L and 0.59 mol/L,
and, after the predetermined period, the method comprises rinsing the portion of the part with water.

In addition, the applicator member enables the anti-corrosion substance to be applied by means of a localized deposit on the portion of the part. The anti-corrosion substance can then impregnate the area of the part to be treated so that the permanganate ions can react with the magnesium of the alloy forming the part.

Such an applicator member may be, for example, selected from a brush, a roller, a pad, a cloth or a sponge.

The epoxy gel can make the anti-corrosion substance viscous, make it adhere to the part at room temperature and thus constitute a stable carrier medium for the chemical ingredients dissolved in the anti-corrosion substance, while limiting the risk of dripping and infiltration. Such an anti-corrosion substance is therefore less fluid than an aqueous solution and the epoxy gel is a medium compatible with the dissolved chemical components, permanganate ions MnO₄⁻ and dihydrogen phosphate ions H₂PO₄⁻.

In addition, such an epoxy gel may comprise at least one epoxy resin and a curing agent.

Furthermore, the epoxy resin contained in the epoxy gel may advantageously be selected from the group comprising resins based on bisphenol A (BPA), resins based on bisphenol F (BPF), novolaks, aliphatics, glycidylamines and biosourced resins.

By way of non-limiting example, the epoxy gel used in the anti-corrosion substance may be a gel marketed under the brand name BONDERITE® with the reference M-AD BASE EP by Henkel AG & Co. KGaA.

Furthermore, before contact with the part, the pH of the anti-corrosion substance may have a value greater than or equal to 3.2 and less than or equal to 4.2 and preferably greater than or equal to 3.4 and less than or equal to 4.0.

In practice, the anti-corrosion substance can be obtained by mixing the epoxy gel with a powder containing potassium permanganate KMnO₄ and potassium dihydrogen phosphate KH₂PO₄ in the solid state.

The above-mentioned molar concentrations as well as the pH value enable a particularly fine layer to be obtained, with optimum corrosion resistance, in particular saline corrosion resistance according to standard ISO 9227. The layer formed also has a suitable surface finish and roughness for ensuring optimal adhesion to paint systems and varnishes, that is the main function sought.

In contact with the anti-corrosion substance of the disclosure, the magnesium of the alloy is attacked by permanganate ions according to the following reversible chemical reaction (1):

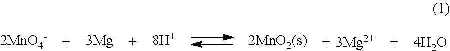

A porous layer of solid manganese oxide MnO₂ forms on the surface of the treated part or portion. Due to the combination of the pH value and the particular concentrations of permanganate ions and dihydrogen phosphate ions contained in the anti-corrosion substance, the ions then precipitate into magnesium phosphate Mg(PO₄)₂ and magnesium permanganate Mg(MnO₄)₂ and plug the pores of the manganese oxide layer. Furthermore, said layer remains less than 5 μm thick due to the values of the aforementioned ionic concentrations and the pH at which the anti-corrosion substance is initially found.

In the indicated pH range, phosphate ions are in the majority. They can also clog the porous layer of manganese oxide or transform in said layer into phosphoric acid, that will precipitate in situ once the part is no longer in contact with the anti-corrosion substance, thus clogging the pores of the anti-corrosion layer.

Advantageously, the molar concentration of permanganate ions may be greater than or equal to 0.08 mol/L and less than or equal to 0.18 mol/L and in particular equal to 0.13 mol/L.

According to an advantageous embodiment of the disclosure, the predetermined time may be greater than or equal to 1 minute and less than or equal to 10 minutes, and preferably greater than or equal to 3 minutes and less than or equal to 7 minutes

The predetermined duration may thus be greater than or equal to 4 minutes and less than or equal to 6 minutes. Such values enable a porous layer of manganese oxide less than 5 μm thick to be obtained, having a microscopic structure with good adhesion for varnishes and anti-corrosion paint systems, as well as good anti-corrosion resistance to neutral salt spray according to standard ISO 9227. A chemical affinity also exists between the nature of the porous layer of manganese oxide and the nature of the paints.

The thus reduced predetermined period for implementation of the method, can improve its industrialization.

In practice, when the portion of the part is brought into contact, at least locally, with the anti-corrosion substance, the anti-corrosion substance can have a temperature equal to an ambient air temperature.

In addition, the solubility limit of permanganate ions can be advantageously increased by increasing the value of the temperature of the anti-corrosion substance. This temperature enables the concentration of the substance in permanganate ions to be optimized, in order to reach the concentration levels necessary to obtain a high-performance anti-corrosion coating that guarantees optimal adhesion to paint systems.

The use of an anti-corrosion substance at ambient temperature can simplify the industrialization of such a treatment process.

Advantageously, the anti-corrosion substance may have a dynamic viscosity between 1 pascal second (Pa·s) and 1000 Pa·s.

Such a range of values for the viscosity of the anti-corrosion substance thus enables it to remain in contact with the part or portion treated, regardless of its shape, size or orientation.

Such a dynamic viscosity of the anti-corrosion substance allows application to a vertically oriented surface of a part, without flowing on that surface at room temperature.

In practice, the anti-corrosion substance may be stirred prior to bringing it into contact with the part. Such stirring may advantageously be carried out manually by means of a dedicated device, such as a stirrer.

Advantageously, regardless of the embodiment of the disclosure, the anti-corrosion substance may also contain ions selected from potassium, ammonium, sodium and calcium ions, and the mixtures thereof. These ions come from the use of one or more dihydrogen phosphate salts. Advantageously, regardless of the embodiment of the method of the disclosure, the anti-corrosion substance of the disclosure consists, before contact with the part, of water in the presence of the epoxy gel, hydronium ions H₃O⁺, potassium ions K+, permanganate ions MnO₄⁻ and phosphate ions PO₄³⁻.

In another advantageous example of the disclosure, the part may be made of a magnesium alloy selected from alloys of magnesium and of at least one rare earth and optionally containing at least one metal selected from aluminum, zinc, silicon, manganese, copper, zirconium and the mixtures thereof, and in particular from magnesium alloys containing aluminum, neodymium, gadolinium, zinc and zirconium.

In particular, the alloy may contain or consist of magnesium, aluminum, neodymium, gadolinium, and zirconium. For example, the part may be made of EV31A alloy.

In practice, before the part or portion to be treated is brought into contact with the anti-corrosion substance, the method may comprise at least one pre-treatment of the part or this portion, selected from the following treatments and the combinations thereof:
alkaline degreasing;
nitric acid pickling followed by hydrofluoric acid pickling;
ammonium bifluoride pickling;
potassium bifluoride pickling;
sodium bifluoride pickling;
sandblasting followed by alkaline degreasing;
degreasing using a solvent;
aqueous degreasing;
pickling of the residues from the magnesium treatments; and
simultaneously or successively, bringing into contact with at least one compound selected from sodium hydroxide, hydrogen peroxide, acetic acid, sulfuric acid, hydrofluoric acid, sodium bifluoride, ammonium bifluoride, phosphoric acid, tartaric acid and hydrochloric acid.

Such a surface preparation of the part or the portion of the part then enables the effectiveness of the anti-corrosion treatment to be increased.

In addition, such pickling may be carried out by a light mechanical process using, for example, an abrasive pad with a pickling solution described above.

Another object of the present disclosure is an anti-corrosion substance used during the contacting of the aforementioned method.

According to the disclosure, such an anti-corrosion substance has a pH greater than or equal to 3.2 and less than or equal to 4.2 and preferably greater than or equal to 3.4 and less than or equal to 4.0, contains permanganate ions at a molar concentration greater than or equal to 0.06 mol/L and less than or equal to 0.31 mol/L and preferably greater than or equal to 0.08 mol/L and less than or equal to 0.18 mol/L and in particular equal to 0.13 mol/L and dihydrogen phosphate ions.

The anti-corrosion substance of the disclosure may also contain ions selected from potassium, ammonium, sodium, calcium ions and the mixtures thereof. These ions come from the use of one or more dihydrogen phosphate salts. Advantageously, regardless of the embodiment of the method of the disclosure, the anti-corrosion substance of the disclosure may, before contact with the part, consist of water, potassium ions K⁺, permanganate ions MnO₄⁻ and phosphate ions PO₄³⁻.

According to a preferred embodiment, the anti-corrosion substance is obtained by mixing a powder containing potassium permanganate KMnO₄ and potassium dihydrogen phosphate KH₂PO₄ in the solid state with an epoxy gel. This anti-corrosion substance may then have a concentration by mass of potassium dihydrogen phosphate greater than or equal to 55 g/L and less than or equal to 95 g/L, preferably greater than or equal to 60 g/L and less than or equal to 80 g/L, a concentration by mass of potassium permanganate greater than or equal to 10 g/L and less than or equal to 50 g/L, preferably greater than or equal to 15 g/L and less than or equal to 30 g/L. Advantageously, the anti-corrosion substance may also have a pH greater than or equal to 3.2 and less than or equal to 4.2 and preferably greater than or equal to 3.4 and less than or equal to 4.0.

The present disclosure also relates to a magnesium alloy part comprising, at least at one surface of a portion of the part, an anti-corrosion layer obtained using the above-mentioned method.

Advantageously, the anti-corrosion layer may contain manganese oxide and at least one phosphate, in particular magnesium phosphate, and the anti-corrosion layer may have a thickness of less than 5 μm.

The manganese oxide layer is porous and its pores are occupied by phosphate molecules. Other ions of the aqueous anti-corrosion solution may also be present.

In practice, the part may be formed from a magnesium alloy selected from alloys of magnesium and of at least one rare earth and containing at least one metal selected from aluminum, zinc, silicon, manganese, copper, zirconium and the mixtures thereof, and in particular from magnesium alloys containing aluminum, neodymium, gadolinium, zinc and zirconium.

In particular, the alloy may contain or consist of magnesium, aluminum, neodymium, gadolinium, and zirconium. The part may be made of EV31A alloy for example, or may have an EV31A alloy layer or portion.

According to one embodiment of the disclosure, the anti-corrosion layer may be electrically conductive and may have a standard potential difference ΔE with respect to the standard potential of the alloy of said part greater than 1 V, and in particular greater than or equal to 1.1 V, 1.2 V, 1.3 V or 1.4 V and/or wherein said anti-corrosion layer resists corrosion for at least 20 hours, and in particular 24 hours, caused by accelerated ageing and/or the anti-corrosion layer may have a rating 0 or 1 for adhesion to paint according to the standard ISO 2409.

### Definitions

The term “phosphate” refers to some of the constituents of phosphoric acid, dihydrogen phosphate ions, hydrogen phosphate ions, phosphate ions and the mixtures thereof.

### BRIEF DESCRIPTION OF THE DRAWINGS

Other features and advantages of the disclosure will become apparent on reading the following description, with reference to the appended drawings, wherein:

FIGS. 1 and 2 represent two anti-corrosion treated test pieces that are then subjected for 24 hours to the accelerated-aging corrosion test. The test piece of FIG. 1 was treated locally according to the method of the disclosure and has a treatment layer with a thickness of less than 5 μm and, for example, between 0.5 μm and 1 μm, while the test piece of FIG. 2 was treated with a retouching solution marketed under the name “DOW19” and containing Cr6+ ions; and

FIGS. 3 and 4 represent two test pieces previously coated with a primer and then anti-corrosion treated and subjected for 24 hours to the accelerated-aging corrosion test. The test piece of FIG. 3 was treated locally according to the method of the disclosure and has a treatment layer with a thickness of less than 5 μm and, for example, between 0.5 μm and 1 μm, while the test piece of FIG. 4 was treated with a retouching solution, “DOW19” containing Cr6+ ions.

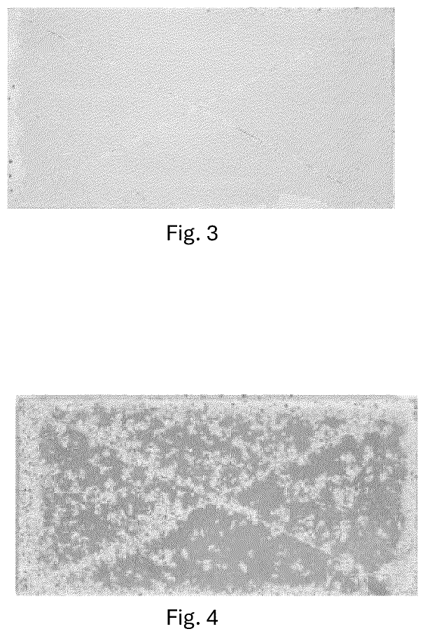

### DETAILED DESCRIPTION

### Examples

### Example 1: Particular Embodiment of the Method of the Disclosure

### Preparation of the Anti-Corrosion Substance

In practice, for an industrial application of the non-immersion contact treatment method, an anti-corrosion substance may be prepared in a container.

As an illustrative example, a powder comprising potassium permanganate KMnO₄ in the solid state is dissolved in a few centiliters of epoxy gel, making it possible to obtain a molar concentration of permanganate ions equal to 0.13 mol/L with potassium dihydrogen phosphate KH₂PO₄ in the solid state, in order to obtain a molar concentration of dihydrogen phosphate ions of between 0.47 mol/L and 0.63 mol/L, and preferably between 0.51 mol/L and 0.59 mol/L, or even equal to 75 g/L, so as to obtain an anti-corrosion substance whose pH is greater than or equal to 3.4 and less than or equal to 3.6 and in particular equal to 3.5.

In order to obtain such a mixture, the powder comprising potassium permanganate KMnO₄ and potassium dihydrogen phosphate KH₂PO₄ in the solid state can be mixed manually in an epoxy gel. Such an epoxy gel is chemically inert with the permanganate ions MnO₄₋ and dihydrogen phosphate ions H₂PO₄⁻, in order to obtain the chemical species to be applied, at least locally, on the part.

### Pretreatment of the Part

A portion of the part or the entire part may undergo a pretreatment selected from the group consisting of: alkaline degreasing, nitric acid pickling followed by hydrofluoric acid pickling, ammonium bifluoride pickling, potassium bifluoride pickling, sodium bifluoride pickling, sandblasting followed by alkaline degreasing, solvent degreasing, aqueous degreasing, pickling of residues from magnesium treatments and simultaneously or successively bringing into contact with at least one compound selected from sodium hydroxide, hydrogen peroxide, acetic acid, sulfuric acid, hydrofluoric acid, sodium bifluoride, ammonium bifluoride, phosphoric acid, tartaric acid, and hydrochloric acid.

Such a surface preparation of the part or the portion of the part then enables the effectiveness of the anti-corrosion treatment to be increased.

In addition, such a pre-treatment may be carried out by a light mechanical process using, for example, an abrasive pad with a pickling solution described above.

### Handling of the Part

The temperature of the anti-corrosion substance is that of the ambient air. Using an applicator, such as a brush or a roller for example, the anti-corrosion substance present in the container is removed and deposited on the part or portion of the part to be treated for a predetermined period greater than or equal to 3 minutes and less than or equal to 7 minutes

When the predetermined treatment period has elapsed, the anti-corrosion substance is wiped off and the part is rinsed with deionized water. The part thus treated can then be blown or dried.

### Investigation of the Properties of the Anti-Corrosion Layer Formed

The anti-corrosion layer formed is visible because it has a brown color (light pink/golden or matt beige to dark brown). The thickness of the anti-corrosion layer is less than 5 μm.

The anti-corrosion layer formed by the method of the disclosure is electrically conductive.

The corrosion resistance of the anti-corrosion layer obtained according to the method of the disclosure, to accelerated aging was measured. The part treated according to the method of the disclosure resists for 24 hours before the appearance of the first corrosion pits.

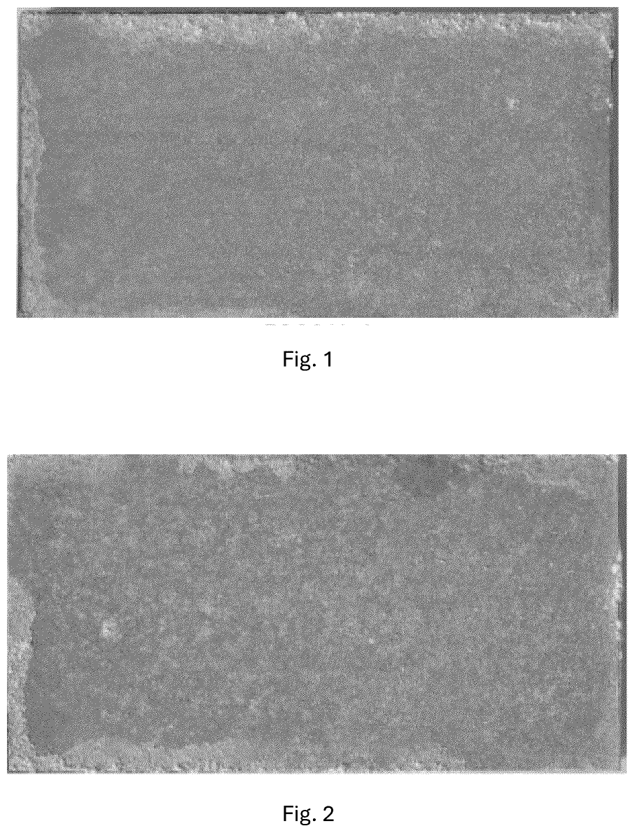

FIG. 2 clearly shows that the test piece treated with a DOW19 retouching solution and containing Cr6+ ions and subjected to the so-called neutral salt spray corrosion test for 24 hours, has a completely corroded surface. By contrast, the test piece treated according to the method of the disclosure, illustrated in FIG. 1, has an uncorroded surface after 24 hours of the same test.

The corrosion resistance of the anti-corrosion layer obtained according to the method of the disclosure and coated with a neutral salt spray varnish according to ISO 9227 was also measured. The part according to the disclosure and coated with varnish resists for more than 250 hours before the appearance of the first corrosion pits.

The corrosion resistance of the anti-corrosion layer obtained according to the method of the disclosure, coated with a paint system comprising a primer and a finish or varnish and subjected to accelerated ageing, was also measured. The paint-coated part of the disclosure resists for more than 1000 hours before the first corrosion pits appear.

The adhesion of varnishes and paints has been tested according to standard ISO 2409. It has been shown that the anti-corrosion layer obtained according to the method of the disclosure has a rating of 0 in terms of adhesion to paint according to the aforementioned standard. After wet aging, and still according to the aforementioned standard, the anti-corrosion layer obtained according to the method of the disclosure has a rating of 1 in terms of adhesion to paint (according to standard ISO 2409). The ageing cycle lasts for a period of 24 hours and is broken down as follows: 6 hours of exposure in a humid environment: 80% RH, 40° C., then immersion for 15 minutes in a saline solution (5% NaCl) and the rest of the time, drying cycle in ambient air.

### Accelerated Ageing Tests in Climatic Chambers

Furthermore, ageing cycles as indicated in the previous paragraph on the anti-corrosion treated EV31A alloy reveal the presence of first corrosion pits after two 24-hour cycles for a part treated by chromium etching, whereas after the fifteenth 24-hour cycle no pitting is detected in the case of a part comprising an anti-corrosion layer obtained according to the method of the disclosure and having a thickness of less than 5 μm.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

What is claimed is:

1. A method for anti-corrosion treatment of a magnesium alloy part, the method comprising bringing a portion of the part, at least locally, into contact with an anti-corrosion substance for a predetermined period, using an applicator member,
wherein the anti-corrosion substance contains:
permanganate ions MnO₄⁻;
dihydrogen phosphate ions H₂PO₄⁻; and
an epoxy gel, the pH of which is between 6 and 8,
after mixing, the anti-corrosion substance comprising a molar concentration of permanganate ions [MnO₄⁻] greater than or equal to 0.06 mol/L (moles per liter) and less than or equal to 0.31 mol/L, and a molar concentration of dihydrogen phosphate ions [H₂PO₄⁻] greater than or equal to 0.47 mol/L (moles per liter) and less than or equal to 0.63 mol/L, and preferably between 0.51 mol/L and 0.59 mol/L,
and wherein, after the predetermined period, the method comprises rinsing the portion of the part with water.

2. The method according to claim 1,
wherein the anti-corrosion substance is obtained by mixing the epoxy gel with a a powder containing potassium permanganate KMnO₄ and potassium dihydrogen phosphate KH₂PO₄ in the solid state.

3. The method according to claim 1,
wherein the molar concentration of permanganate ions [MnO₄⁻] is greater than or equal to 0.08 mol/L and less than or equal to 0.18 mol/L and in particular equal to 0.13 mol/L.

4. The method according to claim 1,
wherein the predetermined period is greater than or equal to 1 minute and less than or equal to 10 minutes and preferably greater than or equal to 3 minutes and less than or equal to 7 minutes.

5. The method according to claim 1,
wherein, when the portion of the part is brought into contact, at least locally, with the anti-corrosion substance, the anti-corrosion substance has a temperature equal to an ambient air temperature.

6. The method according to claim 1,
wherein the anti-corrosion substance has a dynamic viscosity between 1 pascal-second (Pa·s) and 1000 pascal-seconds (Pa·s).

7. The method according to claim 1,
wherein the part is formed from a magnesium alloy selected from alloys of magnesium and at least one rare earth, and containing at least one metal selected from aluminum, zinc, silicon, manganese, copper, zirconium and the mixtures thereof.

8. The method according to claim 1,
wherein, before the part is brought into contact with the anti-corrosion substance, the method comprises at least one pretreatment of the part selected from the following treatments and the combinations thereof:
alkaline degreasing;
nitric acid pickling followed by hydrofluoric acid pickling;
ammonium bifluoride pickling;
potassium bifluoride pickling;
sodium bifluoride pickling;
sandblasting followed by alkaline degreasing;
degreasing using a solvent;
aqueous degreasing;
simultaneously or successively, bringing into contact with at least one compound selected from sodium hydroxide, hydrogen peroxide, acetic acid, sulfuric acid, hydrofluoric acid, sodium bifluoride, ammonium bifluoride, phosphoric acid, tartaric acid, hydrochloric acid.

9. An anti-corrosion substance used during the contacting of the method according to claim 1,
wherein the anti-corrosion substance has a pH greater than or equal to 3.2 and less than or equal to 4.2 and preferably greater than or equal to 3.4 and less than or equal to 4.0, contains permanganate ions in a molar concentration [MnO₄-] greater than or equal to 0.06 mol/L and less than or equal to 0.31 mol/L and preferably, greater than or equal to 0.08 mol/L and less than or equal to 0.18 mol/L and in particular equal to 0.13 mol/L and dihydrogen phosphate ions.

10. A part made of magnesium alloy, comprising, at least at one surface of a portion of the part, an anti-corrosion layer obtained using the method according to claim 1.

11. The part according to claim 10,
wherein the anti-corrosion layer contains manganese oxide and at least one phosphate, in particular magnesium phosphate, and wherein the anti-corrosion layer has a thickness of less than 5 μm.

12. The part according to claim 10,
wherein the part is made of a magnesium alloy selected from alloys of magnesium and at least one rare earth, and optionally containing at least one metal selected from aluminum, zinc, silicon, manganese, copper, zirconium and the mixtures thereof.

13. The part according to claim 10,
wherein the anti-corrosion layer is electrically conductive and has a standard potential difference ΔE with respect to the standard potential of the alloy of the part greater than 1 V and in particular greater than or equal to 1.1 V, 1.2 V, 1.3 V or 1.4 V, and/or wherein the anti-corrosion layer resists corrosion for at least 20 hours, and in particular 24 hours, caused by accelerated aging and/or wherein the anti-corrosion layer has a rating of 0 or 1 for adhesion to paint according to standard ISO 2409.
